(19) United States
(12) Patent Application Publication
(10) Pub. No.: US 2008/0189114 A1
(43) Pub. Date: Aug. 7, 2008

(54) METHOD AND APPARATUS FOR ASSISTING VISION IMPAIRED INDIVIDUALS WITH SELECTING ITEMS FROM A LIST

(76) Inventors: KEITH W. FAIL, Austin, TX (US); Roy A. Feigel, Austin, TX (US); Barry A. Feigenbaum, Austin, TX (US)

Correspondence Address: Richard A. Henkler, 117 Old Stage Road, Essex, VT, 05452, US

(21) Appl. No.: 12/059,612

(22) Filed: Mar. 31, 2008

Related U.S. Application Data
(63) Continuation of application No. 11/274,845, filed on Nov. 15, 2005.

(51) Int. Cl. G10L 21/06

(52) U.S. Cl. 704/271; 704/E21.001

(57) ABSTRACT

A method, system, and computer program product for assisting individuals with vision impairment in their selection of items that are typically displayed in a list.

### CROSS-REFERENCE TO RELATED APPLICATION

This is a continuation of co-pending application Ser. No. 11/274,845, filed Nov. 15, 2005, and titled A Method and Apparatus for Assisting Vision Impaired Individuals with Selecting Items from a List.

### BACKGROUND

1. Technical Field of the Present Invention

The present invention generally relates to electronic devices, and more specifically, to electronic devices that assist individuals in the process of selecting items from a list of selectable items.

2. Description of Related Art

Technological advances have allowed the electronic industry to take a more active and, often times, critical role in assisting individuals with various disabilities. In particular, these advances have enhanced the number options in which information can be presented to an individual.

The ability to present information to individuals with vision impairment has been improved using software solutions such as text-to-speech and speech recognition, and hardware solutions such as text-to-brail and specialized screen displays.

Unfortunately, the above noted solutions and others have been limited to the use of personal computers such as desktops. The desire for assistance by individuals with vision impairment is not limited to their homes, but rather, in every place information is presented.

This is particular evident in places such as restaurants where menus are provided in a printed format. The individual will often require a specialized menu in a Braille format or assistance from another individual (e.g. waiter) to read the menu to them.

It would, therefore, be a distinct advantage to have a portable device capable of presenting various types of information to an individual who has vision impairment.

### SUMMARY OF THE PRESENT INVENTION

In one aspect, the present invention is an apparatus for assisting an individual with vision impairment. The apparatus includes a pressure sensitive screen for displaying a list of items and receiving input from the individual concerning their selection of one or more of the items. The apparatus further includes wireless circuitry for communicating information wirelessly. The apparatus also includes voice recognition circuitry for recognizing audio input from the individual concerning their selection of one or more of the items. In addition, the apparatus includes a speaker for providing audio information to the individual.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a diagram illustrating an example of a preferred embodiment of a dedicated device according to the teachings of the present invention;

FIG. 2 is a block diagram illustrating a communication system capable of transmitting and receiving data wirelessly according to the teachings of the present invention;

FIG. 3 is a flow chart is shown illustrating the various communications between the communication system and the dedicated device of FIG. 1 according to the teachings of the present invention; and

FIG. 4 is a diagram illustrating an example of a window that can be displayed in the pressure sensitive screen display of FIG. 1 according to the teachings of the present invention; and

FIGS. 5-8 are diagrams illustrating the window example of FIG. 4 according to the teachings of the present invention.

### DETAILED DESCRIPTION OF THE PREFERRED EMBODIMENT OF THE PRESENT INVENTION

The present invention is a method, system, and computer program product for assisting in the presentation and selection of information to and by individuals having vision impairment. More specifically, the present invention is a mobile electronic device that has various capabilities for presenting information that is typically provided in visual list format.

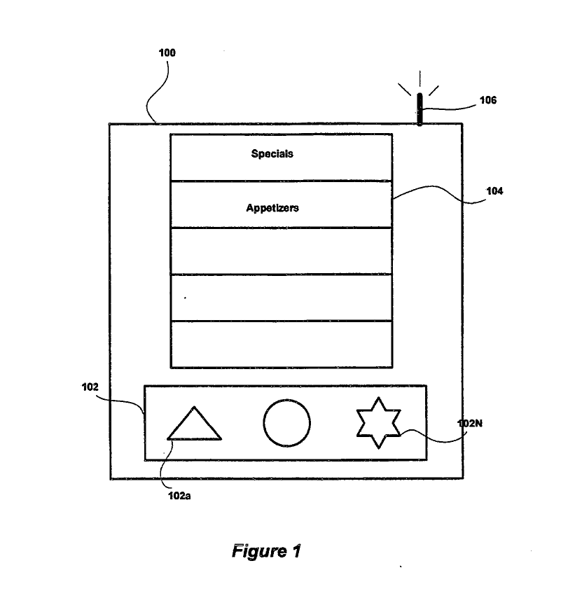

Reference now being made to FIG. 1, a diagram is shown illustrating an example of a preferred embodiment of the present invention. In the preferred embodiment, the present invention is a dedicated device 100 having the capability to display information such as a menu to individuals with various degrees of vision impairment.

The dedicated device 100 includes a pressure sensitive screen display 104 for visually presenting and receiving information to and from the individual. Dedicated device 100 also includes software and hardware for providing the capability of voice recognition. The visual presentation can be, for example, specialized in various characters such as font, colors, and/or placement of specialized buttons and/or controls (which can also be user configurable).

The dedicated device 100 also includes a control unit 102 having one or more controls 102-102N for controlling the various functions of the device 100. The controls 102-102N can be physically distinct from one another by factors such as size, shape, texture, and the like (basically any physical form that would allow an individual to distinguish one control from another).

Dedicated device 100 can also include optional wireless circuitry 106 that is capable of transmitting and receiving data wirelessly. In the preferred embodiment of the present invention, the individual with visual impairment has the option of using voice communication via a wireless headset or earplug (not shown), the touch-screen display 104, the controls 102 or some combination thereof.

Dedicated device 100 can be combined or included with other functionality in another electronic device such as the type used for paging a waiting individual to inform them that their table is ready in a restaurant. In addition, dedicated device 100 can also be embedded in any other location or device that is convenient or practical for the intended individual. For example, the dedicated device 100 can be embedded in a table (not shown).

For ease of explanation, the operation of the dedicated device 100 is explained below in connection with a restaurant environment. It should be noted, however, that the use of the dedicated device 100 is not limited to any particular environment, but rather, preferably used where items are typically displayed in a list format.

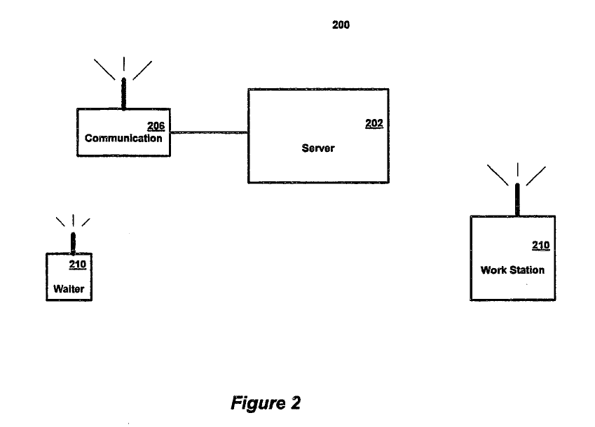

Reference now being made to FIG. 2, a block diagram is shown illustrating a communication system 200 capable of transmitting and receiving data wirelessly according to the teachings of the present invention. Communication system 200 includes wireless communication device 206, server 202, and various other wireless devices such as a waiter communication device 210 and workstation 208. Obviously, the number of wireless devices interacting with Server 202 can be numerous depending on the size of the establishment and number of services offered to patrons.

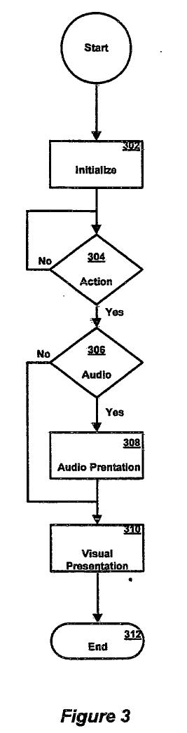

Workstation 208 can, for example, be located in the kitchen or food preparation managing area of a restaurant. Workstation 208 can receive information, as described in connection with FIG. 3, directly from the dedicated device 100 or routed through the Server 202 for tracking orders, food stock depletion and the like.

Reference now being made to FIG. 3, a flow chart is shown illustrating the various communications between the communication system 200 and the dedicated device 100 of FIG. 1 according to the teachings of the present invention. The communication begins with initialization of the dedicated device 100 so that it is updated with the latest menu items (e.g. special of the day), any other information that is capable of being updated (e.g. voice recognition software), and selection of the individuals preferred language (Step 302). The initialization can also include the assignment of one or more particular service individuals to be associated with the dedicated device (e.g. table assignments).

The dedicated device 100 remains idle until an individual performs some predetermined interaction such as powering-up, touching the display 104, controls 102-102N, speaking in the wireless headset, or the like (Step 304). In response to the predetermined interaction, the dedicated device 100 will, if audio is enabled, describe the menu in a pre-selected language to the particular individual (Steps 306 and 308).

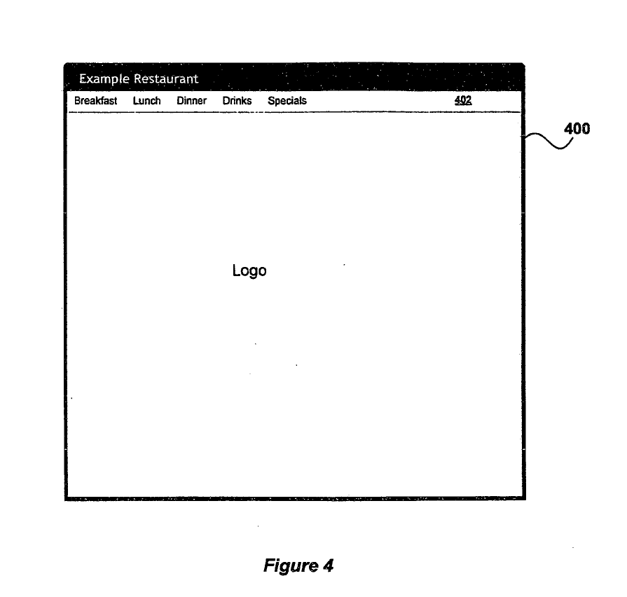

An example of menu type information that can be displayed by the dedicated device 100 is explained below in connection with FIG. 4.

Reference now being made to FIG. 4, a diagram is shown illustrating an example of a window 400 that can be displayed in the pressure sensitive screen display 104 of FIG. 1 according to the teachings of the present invention. In the present example, the window 400 is representative of a window type environment such as Windows 2000™ or XP™. This environment, however, is not intended to be a limitation on the types of graphical representations to which the present invention is applicable, but rather, as a convenient and familiar interface from which to provide an explanation of the present invention.

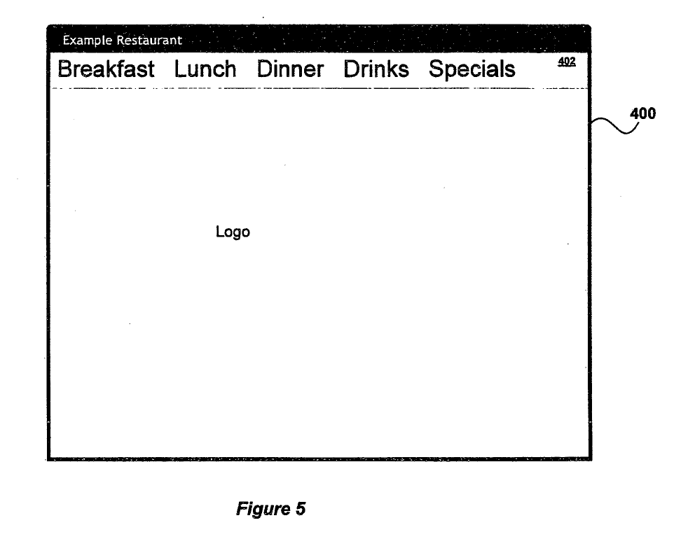

Window 400 includes a menu bar 402 having selections for breakfast, lunch, dinner, specials, and drinks. Since the dedicated device 100 will be available to all individuals, the specialized characters to display the text are in a predetermined size and style. The user or establishment can modify these specialized characters to be larger, change the color, or representation (icons). For example, the size of the fonts can be modified so as to be easier to read as illustrated in FIG. 5.

If the individual has selected audio presentation in addition to the visual, the displayed menu items are spoken to them audibly via a speaker (e.g. wireless headset or earpiece). In addition, the audio delivery of the present invention includes typical repeat and selection process methods to ensure that the indicated selection reflects the desired item of the individual.

The individual can also use a cursor 602 or other device for visually indicating their selection. The device can be a cursor control device such as a mouse. As part of the audible process, the individual can receive audible instructions in combination with the one or more of the controls 102a-n and/or pressure sensitive display 104 to indicate their selection.

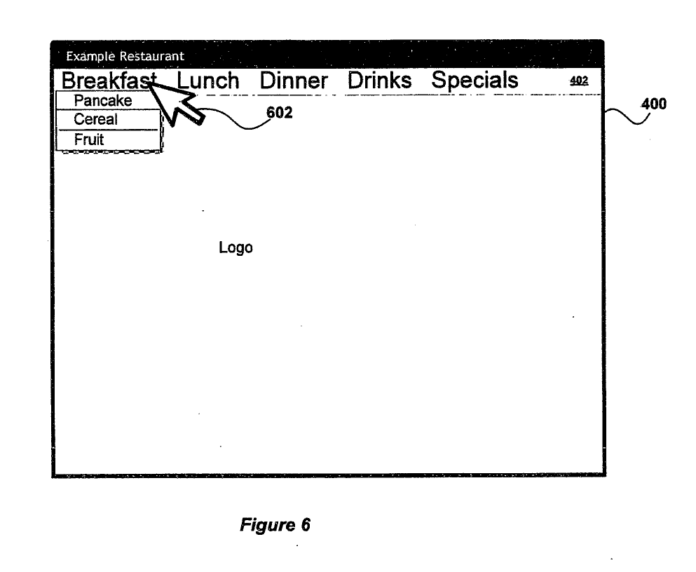

In an alternative preferred embodiment of the present invention, the dedicated device 100 includes speech recognition. In the alternative embodiment, the individual can speak their desire for a menu item such as breakfast into the audio portion of the dedicated device 100, and the breakfast menu will drop down as illustrated in FIG. 6 without any interaction required from the cursor 602 (as shown, the cursor follows the audio commands given by the individual).

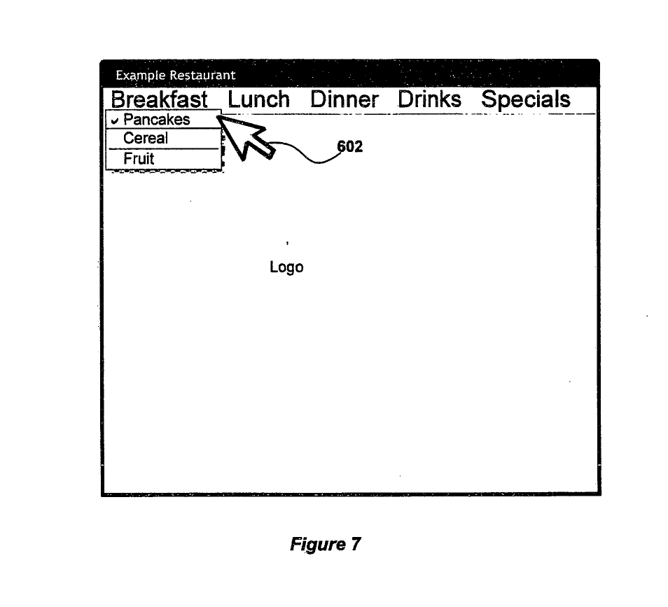

Assuming that the individual desires pancakes for breakfast, they can either speak the word or select the pancake menu item using cursor 602 as illustrated by FIG. 7, one or more of the controls 102a-n, pressure sensitive display 104, or some combination thereof. An initial selection would be verified both audibly (indication of their selection and optionally the ability to verify with speech), if enabled, and with an additional step such as pressing an enter key or other input as previously explained.

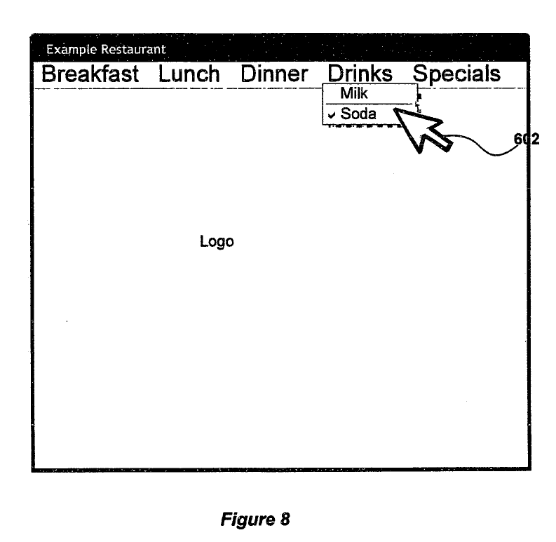

In a similar fashion, the individual can select a drink such as soda as illustrated in FIG. 8.

As previously explained, the menu is also displayed in a typical format that would blend font size and other features as determined by the individual and would reflect any received audio communication from the individual (Step 310). It should also be noted that the individual can, at any time, page a waiter for additional assistance.

Upon completion of their selections the individual communicates their desire to complete their order either with a visual selection or audio command (Step 312).

Depending upon the particular desires of the establishment, the individuals selection is received either at the Server 202 (FIG. 2) and routed to the appropriate workstation 208 or directly by the appropriate workstation 208. Once the food or other service item is ready for delivery to the individual, the waiter or other responsible individual is prompted via pager or other electronic device 210 to pick-up and deliver the food to the waiting individual.

In addition to having a dedicated device 100 for assisting vision impaired individuals, the present invention can also be implemented in existing devices such as PDAs, MP3 players, cell phones, gameboys and the like. Basically, any electronic device that is capable of receiving information wirelessly and voice recognition and/or visual display capabilities. In devices having limited memory or display capabilities, the information can be relayed in a shuffle type fashion or using push technology.

It is thus believed that the operation and construction of the present invention will be apparent from the foregoing description. While the method and system shown and described has been characterized as being preferred, it will be readily apparent that various changes and/or modifications could be made without departing from the spirit and scope of the present invention as defined in the following claims.

What is claimed is:

1. An apparatus for assisting an individual with vision impairment, the apparatus comprising:
a pressure sensitive screen for displaying a list of items and receiving input from the individual concerning their selection of one or more of the items;
wireless circuitry for communicating information wirelessly;
voice recognition circuitry for recognizing audio input from the individual concerning their selection of one or more of the items; and
a speaker for providing audio information to the individual.

2. The apparatus of claim 1 further comprising:
a control panel containing one or more controls each having a unique shape and contour so as to distinguish one from the other.

3. The apparatus of claim 2 wherein the apparatus is a mobile device.

4. The apparatus of claim 2 further comprising:
a mobile electronic device for receiving information concerning the one or more selected items.

5. The apparatus of claim 4 further comprising:
a server for receiving information concerning the one or more selected items and for tracking and renewing inventory according to the one or more selected items.

6. The apparatus of claim 5 further comprising:
a workstation for receiving information from the server concerning the one or more selected items.

7. The apparatus of claim 6 wherein the pressure sensitive screen displays a selection of items.

8. The apparatus of claim 7 wherein the selection of items is spoken to the individual in a pre-selected language.

9. The apparatus of claim 8 wherein the individual selects one or more of the displayed items using the one or more controls.

10. The apparatus of claim 8 wherein the individual selects one or more of the displayed items using the pressure sensitive display.

11. The apparatus of claim 10 wherein the apparatus is a mobile device.

12. The apparatus of claim 10 wherein the apparatus is embedded in a table.

13. A system for assisting an individual in the selection of one or more items from a list of items, the system comprising:
a pressure sensitive display capable of displaying one or more items in a various characters;
a speaker capable of providing audio;
circuitry capable of transmitting an audio representation of the one or more displayed items.

14. The system of claim 13 further comprising:
wireless circuitry capable of providing wireless communication.

15. The system of claim 14 further comprising:
one or more controls each having a shape and texture that is different from the other.

16. The system of claim 15 wherein the one or more controls are used by the individual in combination with the audio presentation to select one or more of the items.

17. The system of claim 13 wherein the speaker is wireless.

18. The system of claim 13 further comprising:
one or more controls each having a shape and texture that is different from the other.

19. The system of claim 18 further comprising:
circuitry capable of presenting an audio presentation of one or more of the items selected by the individual using the one or more controls.

20. The system of claim 19 further comprising:
voice recognition circuitry capable of recognizing the selection of one or more of the items.
